(19) United States
(12) Patent Application Publication
(10) Pub. No.: US 2009/0284500 A1
(43) Pub. Date: Nov. 19, 2009

(54) ACTIVE MATRIX DISPLAY DEVICES AND PORTABLE ELECTRONIC PRODUCTS USING THE SAME

(75) Inventor: Keitaro YAMASHITA, Kobe (JP)

Correspondence Address: LIU & LIU, 444 S. FLOWER STREET, SUITE 1750, LOS ANGELES, CA, 90071, US

(73) Assignee: TPO Displays Corp., Chu-Nan (TW)

(21) Appl. No.: 12/466,023

(22) Filed: May 14, 2009

(30) Foreign Application Priority Data
May 14, 2008 (JP) 2008-127453

(51) Int. Cl. G06F 3/038

(52) U.S. Cl. 345/204; 345/92

(57) ABSTRACT

The display device of the present invention includes a display area having a plurality of pixels arranged in rows and columns, at least one source driving device providing power or electric charges for the pixels through source lines, at least one gate driving device controlling the pixels through gate lines, and a boundary switch separating the display area into a plurality of sub-display areas and placed between the sub-display areas to connect or disconnect the source lines and/or the gate lines. When the boundary switch disconnects the source lines and/or the gate lines, the sub-display area directly connecting with the source driving device or the gate driving device will be driven.

### CROSS REFERENCE TO RELATED APPLICATIONS

This application claims the benefit of J.P. Patent Application No. 2008-127453, filed May, 14, 2008.

### FIELD OF THE INVENTION

The present invention relates to active matrix display devices and portable electronic products using the same, and more particularly to active matrix display devices having a plurality of pixels arranged in rows and columns, and portable electronic products using the same.

### DESCRIPTION OF THE PRIOR ART

An active matrix display device includes a display area having a plurality of pixels arranged in rows and columns. Each pixel has at least one driving transistor and display element (ex. a liquid crystal cell or an organic light-emitting diode), and so on. Every pixel in the same row shares a gate line connecting to a driving transistor thereof. A gate driving device transmits control signals to the pixels through the gate lines to control on/off of the pixels. Every pixel in the same column shares a source line supplying power or electric charges thereto. A source driving device supplies power or electric charges to the pixels through the source lines.

However, parasitic capacitance causing more power consumption exists between the source lines and the gate lines. The problem is especially prevalent, when the active matrix display device is applied in portable battery-driven devices such as mobile phones.

To solve the problems about power consumption, for example, as mentioned in an international application document WO2007/034364A1 (Patent document 1), a part of the display area is used in a standby mode to show at least the essential information about the product conditions, timed residual power, etc.

However, an additional driving device is required, thus increasing costs.

Thus, an active matrix display device having a plurality of pixels arranged in rows and columns, and portable electronic products using the same is provided, wherein power consumption is reduced and requirement for an additional driving device is eliminated.

### SUMMARY OF THE INVENTION

To achieve the objectives of the invention, the active matrix display device of the present invention includes a display area having a plurality of pixels arranged in rows and columns, at least one source driving device providing power or electric charges for the pixels through source lines, at least one gate driving device controlling the pixels through gate lines, and a boundary switch separating the display area into a plurality of sub-display areas and placed between the sub-display areas to connect or disconnect the source lines and/or the gate lines. When the boundary switch disconnects the source lines and/or the gate lines, the sub-display area directly connecting with the source driving device or the gate driving device will be driven.

By setting such a boundary switch, capacitive loads existing on the source lines and the gate lines are reduced. Therefore, every sub-display area has no need to set another source driving device and/or another gate driving device for a special purpose, but a low power consumption active matrix display is provided.

In an embodiment of this invention, the source driving device and the gate driving device are set respectively. The boundary switch separates the display area into a first sub-display area and a second sub-display area and is configured between the two sub-display areas to connect or disconnect the source lines. The first sub-display area and second sub-display area are disposed at the upper and lower side of the boundary switch, respectively. When the boundary switch disconnects the source lines, the sub-display area which is not directly connecting with the source driving device will not be driven. However, the active matrix display device of the invention has a second source driving device. The second source driving device is configured opposite to the source driving device and holds the display area with the source driving device. Thus, as an example, if the gate driving device has two sub-driving areas disconnected by the boundary switch, the sub-display area which is not directly connecting with the source driving device will be driven by the second source driving device and one of the sub-driving areas directly connecting to the sub-display area which is not directly connecting with the source driving device when the boundary switch disconnects the source lines.

In another embodiment of this invention, the source driving device and the gate driving device are set respectively. The boundary switch separates the display area into a first sub-display area and a second sub-display area and is configured between the two sub-display areas to connect or disconnect the gate lines. The first sub-display area and second sub-display area are disposed at the left and right side of the boundary switch, respectively. When the boundary switch disconnects the gate lines, the sub-display area which is not directly connecting with the gate driving device will not be driven. However, the active matrix display device of the invention has a second gate driving device. The second gate driving device is configured opposite to the gate driving device and holds the display area with the gate driving device. When the boundary switch disconnects the gate lines, the sub-display area which is not directly connecting with the gate driving device will be driven by the second gate driving device.

In the active matrix display device of the invention, the boundary switch has a plurality of switch elements. The switch elements are arranged in a line and inserted into the source lines or the gate lines of the sub-display areas. The control terminals of the switch elements all connect to a switch driving device. The switch elements do on/off controls at the same time through control signals provided by the switch driving device. Each of the switch elements has at least one of an n-channel TFT, a p-channel TFT, and a transmission gate.

In the active matrix display device of the invention, the boundary switch has a plurality of demultiplexers when there are different pixels between the sub-display areas. The demultiplexers have switch elements of which the number of switch elements corresponds to the ratio of the number of pixels between the sub-display areas. The demultiplexers are arranged in a line and inserted into the source lines or the gate lines between the sub-display areas. The control terminals of the switch elements all connect to a switch driving device. The switch elements do on/off controls at the same time through control signals provided by the switch driving device.

In the active matrix display device of the invention, the sub-display area separated from the source driving device or the gate driving device has a plurality of pixels with memories, and the memories store the statuses of the pixels of when the boundary switch disconnected from the source lines and/or the gate lines.

Note that light emitting display elements of the pixels in the active matrix display device of the invention are liquid crystal cells or organic liquid crystal display devices with light-emitting diodes or light-emitting diode display devices.

The active matrix display device of the invention may be applied in a portable electronic product such as a mobile phone, a PDA, a walkman, or a portable game console etc. The portable electronic product is typically driven with batteries. Consequently, using the active matrix display device of the invention to restrain power consumption makes the capacity of the batteries decrease slower than before.

Thus, an active matrix display device having a plurality of pixels arranged in rows and columns, and portable electronic products using the same is provided, wherein parasitic capacitance is decreased and requirement for an additional driving device is eliminated.

### BRIEF DESCRIPTION OF THE DRAWINGS

FIG. 1a is a diagram showing an embodiment of the present invention applied in a mobile phone.

FIG. 1b is a diagram showing an embodiment of the present invention applied in a mobile phone.

FIG. 2 shows a first embodiment of an active matrix display device of the invention.

FIG. 3 shows an area of the display device 2 in FIG. 2.

FIG. 4 shows a second embodiment of an active matrix display device of the invention.

FIG. 5 shows a third embodiment of an active matrix display device of the invention.

FIG. 6 shows a fourth embodiment of an active matrix display device of the invention.

FIG. 7 shows a area of the display device 6 in FIG. 6.

FIG. 8 shows an embodiment of a pixel structure of an active matrix display device of the invention.

### DETAILED DESCRIPTION OF THE PREFERRED EMBODIMENTS

The following paragraphs refer to the drawings for illustrating the preferred embodiments of the invention

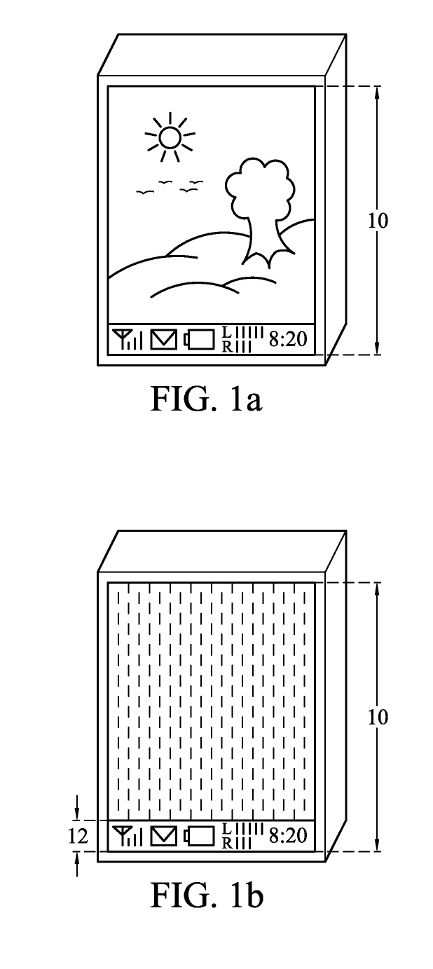

FIG. 1 is a diagram showing an embodiment of the present invention applied in a mobile phone. The diagram is just an example. The present invention may not only be applied in a mobile phone, but also a PDA, a walkman, and a portable game console. In addition to portable electronic products, this invention can be applied in consumer electronic products such as a television and a personal computer, etc.

FIG. 1a shows the display status of a display area 10 in normal mode; FIG. 1b shows the display status of the display area 10 in standby mode. Normal mode means the status wherein the mobile phone is being used by a user, standby mode means the status wherein the mobile phone is not being used by a user and is waiting to be operated by the user. Under the display status shown in FIG. 1a, in order to display images and information, the display area 10 is fully used. But under the display status shown in FIG. 1b, only a part of the display area 10, which is an area 12, is used. In the area 12, essential information such as signal intensity, message status, battery power, and time, etc is shown. The other area in the display area 10, for example, is typically all black and displays nothing when the liquid crystal display is normally black type.

The following paragraphs illustrate specific embodiments of the active matrix display device of the invention for realizing the display status shown in FIG. 1.

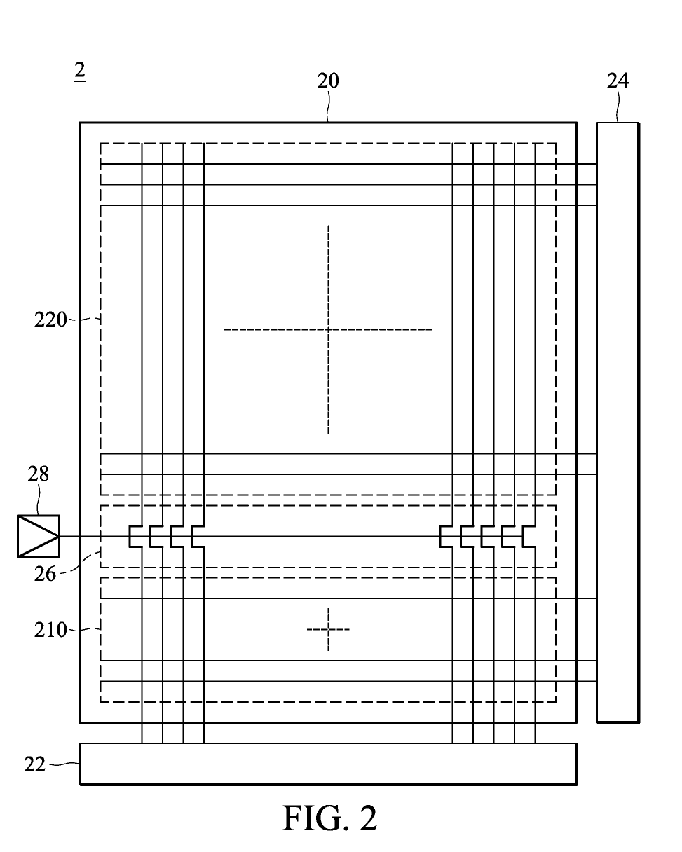

FIG. 2 shows a first embodiment of an active matrix display device of the present invention. A display device 2 in FIG. 2 includes a display area 20, having a plurality of pixels arranged in rows and columns; a source driving device 22, providing power or electric charges for the pixels through source lines; a gate driving device 24, controlling on/off of the pixels through gate lines; a boundary switch 26, separating the display area 20 into a first sub-display area 210 and a second sub-display area 220 and placed therebetween to connect or disconnect the source lines; and a switch driving device 28. The first sub-display area and second sub-display area are disposed at the upper and lower side of the boundary switch 26, respectively. Each pixel has at least one driving transistor and at least one display element (ex. a liquid crystal cell, or an organic light-emitting diode, etc). Every pixel in the same row shares a gate line connecting to its driving transistor. Every pixel in the same column shares a source line supplying power or electric charges thereto.

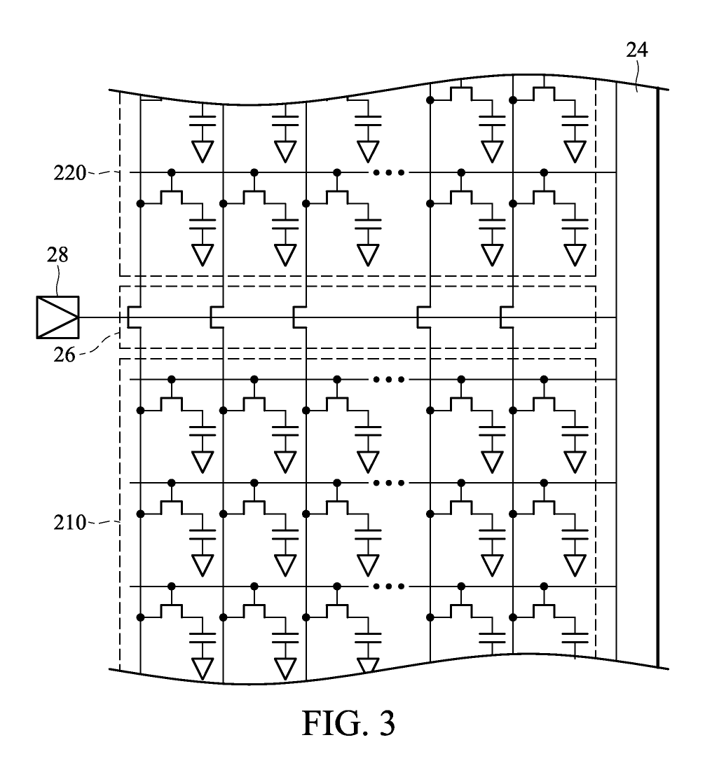

FIG. 3 shows a part of the display device 2 in FIG. 2. The boundary switch 26 has a plurality of n-channel thin film transistors (TFT). The TFTs are arranged in a line and inserted between the first sub-display area 210 and the second sub-display area 220, and the gates of the TFTs connect to the same switch driving device 28. On/off states of the TFTs are controlled at the same time through control signals provided by the switch driving device 28. Note that the boundary switch does not use only n-channel TFTs but also p-channel TFTs, transmission gates, or other switch elements.

As shown in FIG. 2, the source driving device 22 is set below the display area 20 in this embodiment. When the boundary switch 26 is off, power or electric charges are provided to the first sub-display area 210, which is directly connecting to the source driving device 22, but not to the second sub-display area 220, which is above the boundary switch 26. Alternatively, when the boundary switch 26 is on, power or electric charges are also provided to the second sub-display area 220. Therefore, the display status shown in FIG. 1 is realized by the setting of the boundary switch. More specifically, to realize the display status of normal mode shown in FIG. 1a, the boundary switch 26 is on so that power or electric charges are provided the first sub-display area 210 and the second sub-display area 220, which are disposed above and under the boundary switch 26, respectively. Alternatively, to realize the display status of standby mode shown in FIG. 1b, the boundary switch 26 is off so that power or electric charges are provided to only the first sub-display area 210, which is disposed below the boundary switch 26.

Therefore, under standby mode, the second sub-display area 220 is separated from the source driving device 22 by the boundary switch 26, and capacitive loads of the display area and power consumption are reduced successfully.

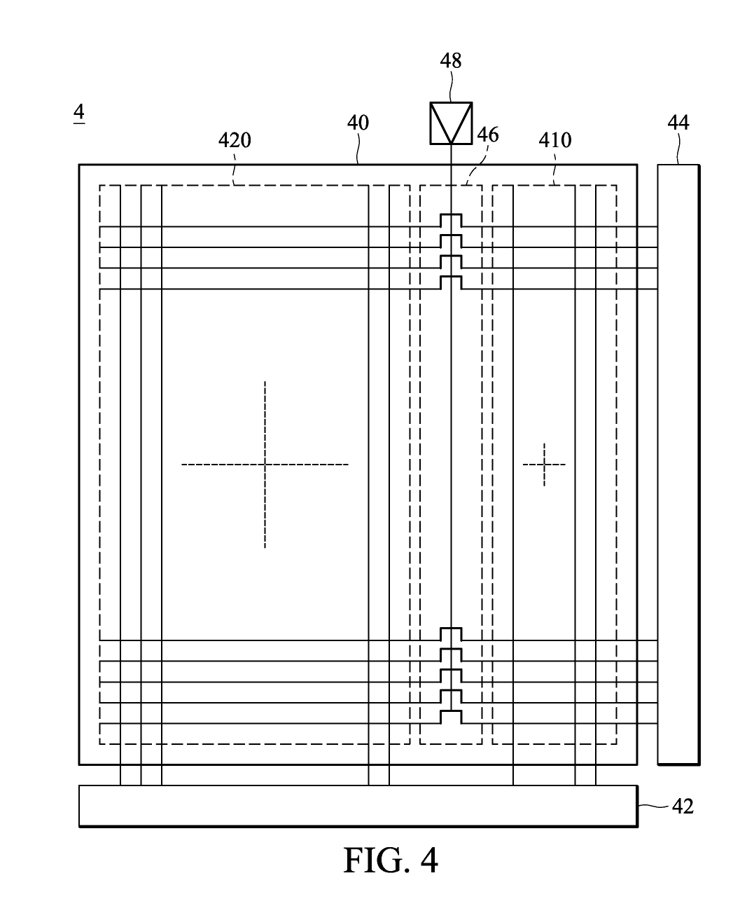

FIG. 4 shows a second embodiment of an active matrix display device of the present invention. A display device 4 in FIG. 4 includes a display area 40, having a plurality of pixels arranged in rows and columns; a source driving device 42, providing power or electric charges for the pixels through source lines; a gate driving device 44, controlling on/off of the pixels through gate lines; a boundary switch 46, separating the display area 40 into a first sub-display area 410 and a second sub-display area 420 and placed therebetween to connect or disconnect the gate lines; and a switch driving device 48, controlling on/off of the boundary switch 46. The first sub-display area and second sub-display area are disposed at the left and right side of the boundary switch 46, respectively. Each pixel has at least one driving transistor and at least one display element (ex. a liquid crystal cell, or an organic light-emitting diode, etc). Every pixel in the same row shares a gate line connecting to its driving transistor. Every pixel in the same column shares a source line supplying power or electric charges thereto.

The display device 4 in this embodiment is different from the display device in the first embodiment in that the boundary switch 46 separates the display area 40 into a first sub-display area 410 and a second sub-display area 420, which are disposed at the left and right side of the boundary switch, respectively and connects or disconnects the gate lines therebetween (refer to FIG. 2).

As shown in FIG. 4, the gate driving device 44 is set at the right side of the display area 40 in this embodiment. When the boundary switch 46 is off, control signals transmitted from the gate driving device 44 are provided to the first sub-display area 410, which is disposed at the right side of the boundary switch 46, but not to the second sub-display area 420, which is at the left side of the boundary switch 46. Alternatively, when the boundary switch 46 is on, control signals transmitted from the gate driving device 44 are also provided to the second sub-display area 420. More specifically, to realize the display status of normal mode shown in FIG. 1a, the boundary switch 46 is on so that control signals are provided to the first sub-display area 410 and a second sub-display area 420, which are disposed at the right and left sides of the boundary switch 46, respectively. Alternatively, to realize the display status of standby mode shown in FIG. 1b, the boundary switch 46 is off so that control signals are provided to only the first sub-display area 410, which is disposed at the right side of the boundary switch 46.

Therefore, in the display device 4 of this embodiment, the sub-display area not used (that is the second sub-display area 420) under standby mode is separated from the gate driving device 44 by the boundary switch 46 (unlike the display device 2 in the first embodiment), thus capacitive loads of the display area and power consumption are reduced successfully.

In the display device 4 of the embodiment, another gate driving device (not shown in the Figs.) can be configured at the other side of the display area opposite to the gate driving device 44. The first sub-display area 410 and the second sub-display area 420, divided by the boundary switch 46, are driven by separate gate driving devices so that the sub-displays can display different images respectively.

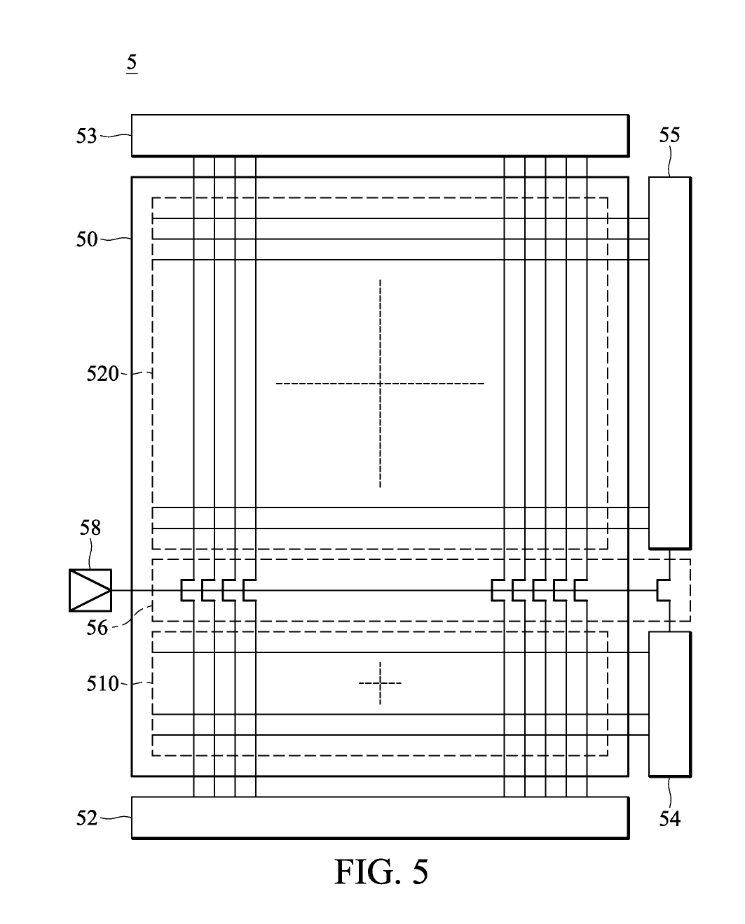

FIG. 5 shows a third embodiment of an active matrix display device of the present invention. A display device 5 in the FIG. 5 includes a display area 50, having a plurality of pixels arranged in rows and columns; source driving devices 52, 53, providing power or electric charges for the pixels through source lines; gate driving devices 54, 55, controlling on/off of the pixels through gate lines; a boundary switch 56, separating the display area 50 into a first sub-display area 510 and a second sub-display area 520 and placed therebetween to connect or disconnect the source lines; and a switch driving device 58, controlling on/off of the boundary switch 56. Each pixel has at least one driving transistor and at least one display element (ex. a liquid crystal cell, an organic light-emitting diode, etc). Every pixel in the same row shares a gate line connecting to its driving transistor. Every pixel in the same column shares a source line supplying power or electric charges thereto.

The display device 5 of this embodiment is different from the display device (refer to FIG. 2) of the first embodiment in that two source driving devices and two gate driving devices are arranged. In the embodiment, the source driving devices 52, 53 are arranged above and below the display area 50. Alternatively, the gate driving devices 54, 55 are arranged at the top and bottom sides of the display area 50, respectively. Meanwhile, a switch element is inserted between the gate driving devices 54, 55, and the gate driving devices 54, 55 are connected when the switch element is on. Thus, the function of the gate driving devices 54, 55 can also be combined in one gate driving device divided into two areas by setting a switch element outside thereof.

When the boundary switch 56 is off, the first sub-display 510 below the boundary switch 56 is driven by the first source driving device 50 at the bottom of the display area 50 and the first gate driving device 54 below the boundary switch 56. Alternatively, the second sub-display 520 above the boundary switch 56 is driven by the second source driving device 53 above the display area 50 and the second gate driving device 55 above the boundary switch 56. When the boundary switch 56 is on, all of the display area 50 is driven by one of the first and second source devices 52, 53, and the corresponding first and second gate driving devices 54, 55.

Therefore, each sub-display can be driven independently when turning the boundary switch off, separating the display area into a plurality of sub-display areas, and using the source driving device and the gate driving device, wherein, every sub-display area can display a different image.

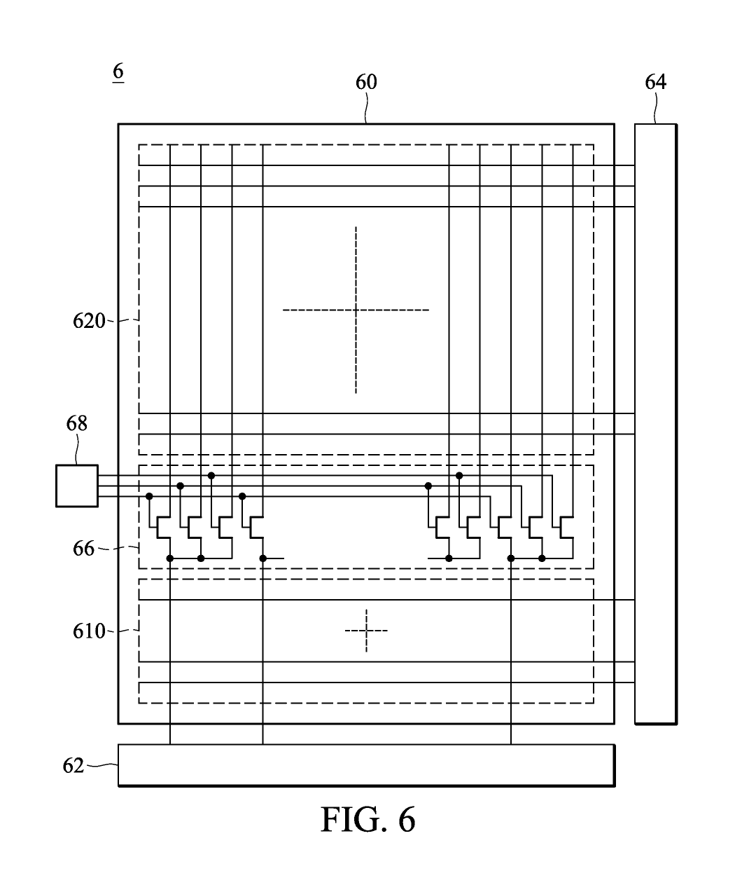

FIG. 6 shows a fourth embodiment of an active matrix display device of the present invention. In this embodiment, the display area has a plurality of sub-display areas, wherein the pixel structures are different. For example, combining a monochromatic display part with a colored display part or combining the sub-display parts having different resolution. This embodiment shows an active matrix display device having the kind of display area.

The display device 6 in FIG. 6 includes a display area 60, having a plurality of pixels arranged in rows and columns; a source driving device 62, providing power or electric charges for the pixels through source lines; a gate driving device 64, controlling on/off of the pixels through gate lines. The display area 60 has a first sub-display area 610 having pixels which emit white light and a second sub-display area 620 having pixels which emit red, blue, and green light. Therefore, the distance between pixels in the second sub-display area 620 is three times larger than that in the first sub-display area 610.

The display area 6 further includes a boundary switch 66, configured between the first and second sub-display areas 610, 620, and a switch driving device 68, controlling on/off of the boundary switch 66. In this embodiment, the boundary switch 66 has a plurality of 1:3 demultiplexers. A source line used by a pixel column of the first sub-display area 610 is divided into three systems and respectively connects to the corresponding three pixel columns of the second sub-display area 620.

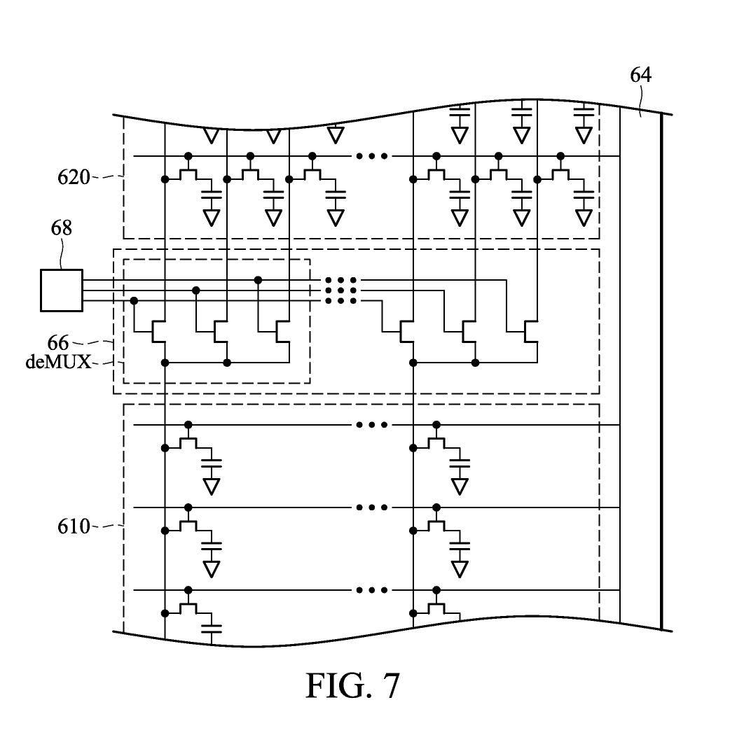

FIG. 7 shows a area of the display device 6 in FIG. 6. The boundary switch 66 has a plurality of 1:3 demultiplexers deMUX. In this embodiment, one of the demultiplexers deMUX has three n-channel thin film transistor (TFT). The n-channel TFTs are selectively turned on or off by signals provided by the switch driving device 68. The demultiplexer deMUX is inserted between the first and second sub-display areas 610, 620. The source line of one pixel column in the first sub-display area 610 is divided into three systems through the demultiplexer deMUX, and connects to the corresponding three pixel columns of the second sub-display area 620. Note that the demultiplexer deMUX does not only use n-channel TFTs but also p-channel TFTs, transmission gates, or other kinds of switch elements.

As shown in FIG. 6, the source driving device of the embodiment is arranged below the display area 60. In a standby mode as shown in FIG. 1b, all of the demultiplexers deMUX included in the boundary switch 66 are turned off. Power or electric charges are provided from the source driving device 62 to the first sub-display area 610, which is directly connecting to the source driving device 62, but not to the second sub-display area 620, which is above the boundary switch 66.

Alternatively, under normal mode shown in FIG. 1a, all of the demultiplexers deMUX included in the boundary switch 66 are turned on in turn within a period for every source line of the second sub-display area 620 to reach a predetermined voltage. Then every pixel of the second sub-display area 620 is driven by control signals provided from the gate lines. The operation of second sub-display area 620 is the same as with conventional method, so detailed description herein is omitted for brevity.

Therefore, by arranging the boundary switch 66, the display status of the display device shown in FIG. 1 is also realized as achievement in the first embodiment. Under standby mode, that the second sub-display area 620 is separated from the source driving device 62 by the boundary switch 26 reduces Capacitive loads of the display area and makes power consumption decrease successfully.

But the embodiment is different from the first embodiment, demultiplexers deMUX are used in the boundary switch. The invention is also suitable for an active matrix display device having a plurality of sub-display areas whose pixel structures are different. Specifically, in the embodiment, the first sub-display area 610 having pixels which emit white light shows the information in monochrome; and the second sub-display area 620 having pixels which emit red, green, and blue light shows the information and images in full color.

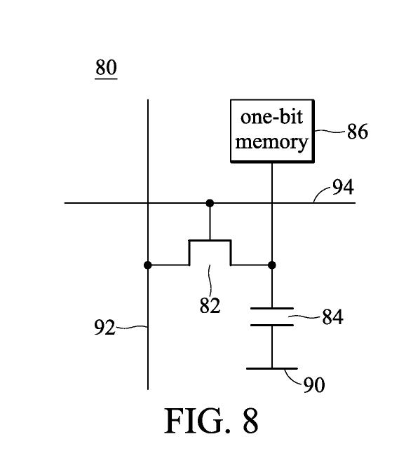

FIG. 8 shows an embodiment of a pixel structure of an active matrix display device of the present invention. In addition to a driving transistor 82 and a display element 84 (ex. a liquid crystal cell, or an organic light-emitting diode), the pixel 80 further includes a one-bit memory 86, which stores the status of the display element 84. One terminal of the display element 84 is connected to a common electrode 90 and the other terminal of the display element 84 is connected to a source line 92 through the driving transistor 82 and also to the memory 86. The gate of the driving transistor 82 is connected to a gate line 94. Control signals from the gate driving device control on/off of the driving transistor 82 through the gate line 94.

By arranging the memory 86, the memory 86 can store the previous status of the pixel 80 when the pixel 80 can't receive power or electric charges from the source line 92 or driving control signals from the gate line 94.

The pixel structure of the present invention is preferably used in the sub-display area separated by the boundary switch. The advantage is specifically illustrated by the active matrix display device of the first embodiment shown in FIG. 2. In a standby mode, the second sub-display area 220 doesn't receive power or electric charges from the source driving device 22 because the boundary switch 26 is off. At this time, every memory 86 of the second sub-display area 220 refreshes and stores the status of the pixel when the boundary switch is off. Therefore, without arranging complex structures, the information or images displayed by the second sub-display area 220 before entering the standby mode can be displayed again when standby mode is switched to normal mode.

The foregoing description is not intended to be exhaustive or to limit the invention to the precise forms disclosed herein. Obvious modifications or variations are possible for those skilled in the art in light of the above teachings.

For example, in the embodiments above, the display area is separated into two areas by a boundary switch, but it can also be separated into more than two areas by a plurality of boundary switches. For example, by arranging the first boundary switch to connect or disconnect source lines and the second boundary switch to connect or disconnect gate lines, the display area can be separated into four sub-display areas. The embodiments above can be used in combination.

1. An active matrix display device, comprising:
a display area, having a plurality of pixels arranged in rows and columns;
at least one source driving device, providing power or electric charges for the pixels through source lines, wherein the number of source lines is equal to the number of columns;
at least one gate driving device, controlling on/off of the pixels through gate lines, wherein the number of gate lines is equal to the number of rows; and
a boundary switch, separating the display area into a plurality of sub-display areas and placed between the sub-display areas to connect or disconnect the source lines and/or the gate lines,
wherein when the boundary switch disconnects the source lines and/or the gate lines, the sub-display areas directly connecting with the source driving device and the gate driving device are driven.

2. The active matrix display device of claim 1, wherein:
the source driving device and the gate driving device are arranged one separately; and
the boundary switch separates the display area into a first sub-display area and a second sub-display area and is configured between the two sub-display areas to connect or disconnect the source lines, wherein the first sub-display area and second sub-display area are disposed at the upper and lower side of the boundary switch, respectively,
wherein when the boundary switch disconnects the boundary switch disconnects the source lines, the sub-display area which is not directly connecting with the source driving device is not driven.

3. The active matrix display device of claim 2, further comprising:
a second source driving device, configured at the other side of the display area opposite to the source driving device,
wherein the gate driving device has two sub-driving areas connected or disconnected by the boundary switch, and
when the boundary switch disconnects the source lines, the sub-display area which is not directly connecting with the source driving device is driven by the second source driving device and one of the sub-driving areas directly connecting this sub-display area.

4. The active matrix display device of claim 1, wherein:
the source driving device and the gate driving device are arranged one separately; and
the boundary switch separates the display area into a first sub-display area and second sub-display area and is configured between the two sub-display areas to connect or disconnect the gate lines, wherein the first sub-display area and second sub-display area are disposed at the left and right side of the boundary switch, respectively,
wherein when the boundary switch disconnects the gate lines, the sub-display area which is not directly connecting with the gate driving device is not driven.

5. The active matrix display device of claim 4, further comprising:
a second gate driving device, configured at the other side of the display area opposite to the gate driving device,
wherein when the boundary switch disconnects the gate lines, the sub-display area which is not directly connecting with the gate driving device is driven by the second gate driving device.

6. The active matrix display device of claim 1, wherein:
the boundary switch has a plurality of switch elements;
the switch elements are arranged in a line and inserted into the source lines or the gate lines of the sub-display areas; and
the control terminals of the switch elements all connect to a switch driving device and the switch elements do on/off controls through control signals provided by the switch driving device at the same time.

7. The active matrix display device of claim 6, wherein each of the switch elements has at least one of an n-channel TFT, a p-channel TFT, and a transmission gate.

8. The active matrix display device of claim 1, wherein:
the boundary switch has a plurality of demultiplexers when there are different pixels between the sub-display areas;
the demultiplexers have switch elements of which the number of switch elements corresponds to the ratio of the number of pixels between the sub-display areas;
the demultiplexers are arranged in a line and inserted into the source lines or the gate lines between the sub-display areas; and
the control terminals of the switch elements all connect to a switch driving device and the switch elements do on/off controls at the same time through control signals provided by the switch driving device.

9. The active matrix display device of claim 1, wherein:
the sub-display area separated from the source driving device or the gate driving device has a plurality of pixels with memories, and
the memories store the statuses of the pixels of when the boundary switch disconnects the source lines and/or the gate lines.

10. The active matrix display device of claim 1, wherein the active matrix display device is a liquid crystal display device.

11. The active matrix display device of claim 1, wherein the active matrix display device is an organic light-emitting diode display device.

12. A portable electronic product, comprising the active matrix display device of claim 1.
